(19) United States
(12) Patent Application Publication
(10) Pub. No.: US 2018/0017689 A1
(43) Pub. Date: Jan. 18, 2018

(54) SENSOR SYSTEM FOR A SEISMOGRAPH

(71) Applicant: Nomis Seismographs, LLC, Birmingham, AL (US)

(72) Inventor: Joseph R. Getz, Keokuk, IA (US)

(73) Assignee: Nomis Seismographs, LLC, Birmingham, AL (US)

(21) Appl. No.: 15/372,014

(22) Filed: Dec. 7, 2016

Related U.S. Application Data
(60) Provisional application No. 62/362,695, filed on Jul. 15, 2016.

(51) Int. Cl. G01V 1/24; G01V 1/18

(52) U.S. Cl. CPC G01V 1/247; G01V 1/184; G01V 1/242

(57) ABSTRACT

A sensor system for a seismograph functions as a hybrid between a digital sensor and an analog sensor. The sensor system has an analog output combined with digital information about the sensor. The sensor system uses both an analog section and a digital section to provide information to a collection device. The digital section can provide digital information regarding the operation of the sensor(s) of the sensor system. After the digital section completes the exchange of digital information, the digital section can be deactivated and the analog section can be used to provide analog sensor information to the collection device. The collection device can use the digital information from the digital section to process the analog sensor information from the analog section.

### CROSS-REFERENCE TO RELATED APPLICATIONS

This application claims the benefit of U.S. Provisional Application No. 62/362,695, entitled “Sensor System for a Seismograph,” and filed Jul. 15, 2016, which application is hereby incorporated by reference in its entirety.

### BACKGROUND

The present application generally relates to a seismograph with a sensor system that can provide both analog and digital information to a collection device.

A seismograph is an instrument that detects and records vibrations and movements of the ground and may also be used to detect and record air over-pressure events and/or sound waves. One use of a seismograph is to measure earthquake activity, but a seismograph may also be used for vibration and sound monitoring activities in other fields such as construction, mining, quarrying and demolition. For example, a seismograph can be used for vibration and sound monitoring during blasting operations, pile driving operations, construction equipment activity, environmental activity, and any other similar operation where a record of vibration and sound is needed.

A seismograph can include a sensor (may also be referred to as a seismometer) to measure vibrations and a collection device (or recording device) to process the information from the sensor. Typically, the sensor is either an analog sensor that provides analog information to the collection device or a digital sensor that provides digital information to the collection device. To provide for proper processing of the sensor information, the collection device has to be configured (or calibrated) for the sensor information to be provided by the sensor. The configuration process is typically a manual process that can be difficult and time-consuming. In addition, if the configuration process is not completed properly, the output data provided by the collection device may be inaccurate and/or unusable.

### SUMMARY

The present application generally pertains to a sensor system for a seismograph. The sensor system can incorporate a geophone design that combines the qualities of both digital and analog sensors, while maintaining separate analog and digital domains. The sensor system (geophone) has an analog output which can be digitized by a collection device of the seismograph at any resolution (number of bits) or number of samples (samples per second). By isolating the analog and digital sections of the sensor system, the sensor system can provide analog data to the collection device accurately and without interference from digital communications. The incorporation of the analog and digital sections into the sensor system enables the collection device to read digital information about the analog output of the sensor system from the digital section and then deactivate (or power off) the digital section before receiving analog information from the analog section. The collection device can use the digital information collected from the digital section for the processing of the analog data provided from the analog section of the sensor system. The digital information from the digital section permits the collection device to determine the appropriate sample rate and resolution for digitizing the analog data from the sensor system.

One advantage of the present application is that the output of the sensor system is not limited in bandwidth.

Another advantage of the present application is the use of the digital information can prevent the collection device from trying to collect information from the analog data in an invalid range and reduce or eliminate user error in configuring the collection device.

A further advantage of the present application is the ability to determine if the sensor is out of calibration and to make an assessment of how accurate the sensor may or may not be.

Other features and advantages of the present application will be apparent from the following more detailed description of the identified embodiments, taken in conjunction with the accompanying drawings which show, by way of example, the principles of the application.

### BRIEF DESCRIPTION OF THE DRAWINGS

FIG. 1 schematically shows an embodiment of a seismograph system.

FIG. 2 schematically shows an embodiment of the collection device of FIG. 1.

FIG. 3 schematically shows an embodiment of the sensor system of FIG. 1.

FIG. 4 schematically shows an embodiment of the analog section of FIG. 3.

FIG. 5 schematically shows an embodiment of the digital section of FIG. 3.

FIG. 6 is a flow chart of an embodiment of a process for providing sensor information to a collection device.

Wherever possible, the same reference numbers are used throughout the drawings to refer to the same or like parts.

### DETAILED DESCRIPTION

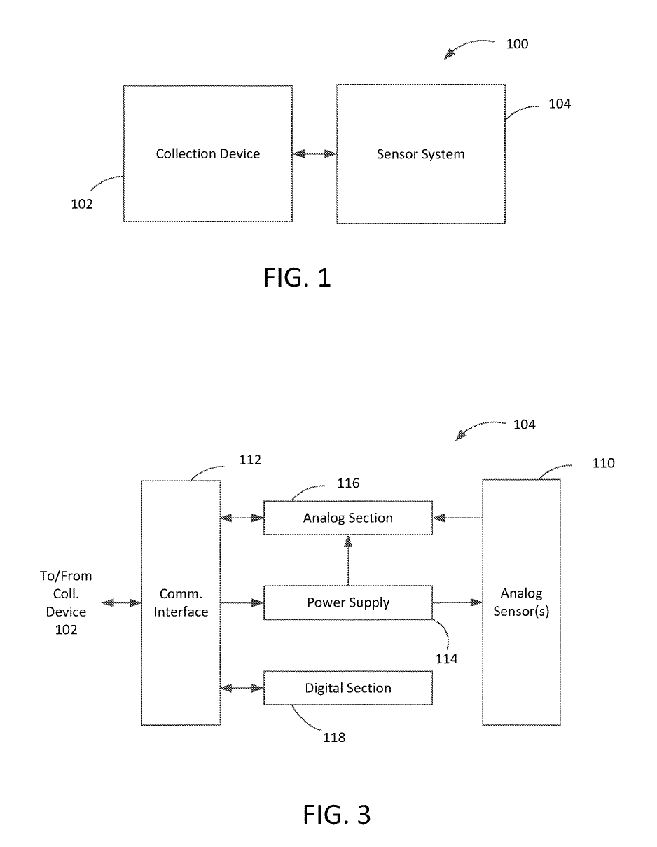

FIG. 1 shows an embodiment of a seismograph system 100. The system 100 includes a sensor system 104 to measure vibrations, movement and/or sound and a collection device 102 to receive and process the measured vibration, movement and/or sound information from the sensor system 104. In another embodiment, the sensor system 104 can also measure parameters such as light, temperature or pressure, in addition to measuring vibration, movement and/or sound, and provide the light, temperature and pressure measurements to the collection device 102. The sensor system 104 can function as a hybrid between a digital sensor and an analog sensor. The sensor system 104 can have an analog output combined with the ability to provide digital information about the sensor. The sensor system 104 can communicate, i.e., send and receive, both analog and digital information with the collection device 102 over a conductive medium (e.g., a wire), fiber, or otherwise, but it is possible in other embodiments for the sensor system 104 to communicate at least some information wirelessly, i.e., via electromagnetic or acoustic waves carrying a signal, with the collection device 102.

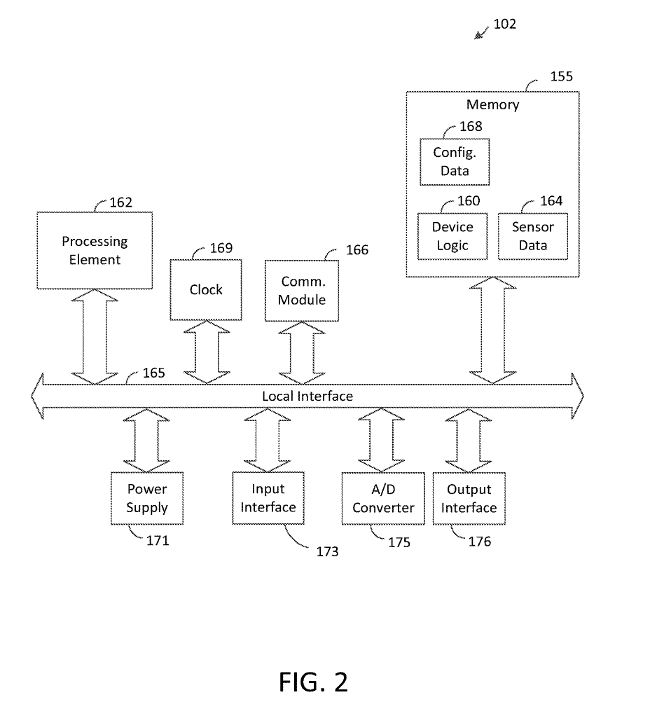

FIG. 2 shows an embodiment of a collection device 102 that can be used with the seismograph system 100. The collection device 102 shown in FIG. 2 can include logic 160, referred to herein as “device logic,” for generally controlling the operation of the collection device 102, including communicating with the sensor system 104. The device logic 160 may be implemented in software, firmware, hardware, or any combination thereof. In the collection device 102 shown in FIG. 2, the device logic 160 is implemented in software and stored in memory 155. However, other configurations of the device logic 160 are possible in other embodiments. The device logic 160, when implemented in software, can be stored and transported on any computer-readable medium for use by or in connection with an instruction execution apparatus that can fetch and execute instructions.

The collection device 102 can include at least one conventional processing element 162, which can incorporate processing hardware for executing instructions stored in the memory 155. As an example, the processing element 162 may include a central processing unit (CPU) or a digital signal processor (DSP). The processing element 162 can communicate to and drive the other elements within the collection device 102 via a local interface 165, which can include at least one bus. The collection device 102 can have a clock 169, which can be used to track time, and a power supply 171, which provides power to the components of the collection device 102. The power supply 171 can include an interface to receive electrical power from an external component, such as an electrical outlet or battery.

The collection device 102 can also have a communication module 166. The communication module 166 can include appropriate components to communicate (wired and/or wirelessly) with the sensor system 104 and/or a network, such as the Internet. In one embodiment, the communication module 166 can also include data ports, such as a USB (universal serial bus) port, Ethernet port, FireWire (IEEE 1394) port, Lightning connector port or other similar port, that can be used for coupling portable devices to the collection device 102 in order to transfer data from the collection device 102 to another computing device (either directly to the computing device, if portable, or via a portable memory device). Furthermore, an input interface 173, for example, a keypad, keyboard or a mouse, can be used to input data from a user of the collection device 102, and an output interface 176, for example, a printer, monitor, liquid crystal display (LCD), or other display apparatus, can be used to output data to the user.

As shown by FIG. 2, sensor data 164 and configuration data 168 can be stored in memory 155 at the collection device 102. The configuration data 168 can include information regarding the operation of the sensor system 104 and the output measurements to be provided by the corresponding sensor(s) of the sensor system 104. In an embodiment, the configuration data 168 can also include information relating to a sample rate for an A/D (analog to digital) converter 175, the distance to the blast (if the sensor system 104 is being used to monitor explosions), the record time for the analog data from the sensor system 104, or other types of information relating to the operation of the collection device 102. In one embodiment, the configuration data 168 can incorporate a CRC (cyclic redundancy check) value into the configuration data 168 to guarantee the integrity of the configuration data 168. At least some of the information stored in configuration data 168 can be received as digital information from the sensor system 104.

The configuration data 168 can be used by the A/D converter 175 in processing (or digitizing) the analog information (or data) communicated from the sensor system 104 to a predetermined number of bits of digital data corresponding to the analog data from the sensor. In one embodiment, the A/D converter 175 can digitize the analog data output from the sensor system 104 into digital data that can vary between a lower resolution value of about 8-bits (1 in 256) to a higher resolution value of about 24-bits (1 in 16777216). In another embodiment, the configuration data 168 can include data that controls the changing of the output resolution from the A/D converter 175 in order to determine very accurate readings over a reduced range in the analog data output by the sensor system 104. The resolution of the A/D converter 175 can be set based on the resolution of the analog data output by the sensor system 104. The maximum resolution for the A/D converter 175 is based on the maximum resolution of the analog data output by the sensor system 104. In other words, the resolution of the A/D converter 175 is limited to the resolution of the analog data that can be output by the sensor system 104.

In addition, the configuration data 168 can be used to establish the sampling rate of the analog data output from the sensor system 104 by the collection device 102 at a predetermined sampling rate. In one embodiment, the A/D converter 175 of the collection device 102 can sample the analog data output from the sensor system 104 at a rate that can vary between about 100 times per second and about 100,000 times per second. In another embodiment, the sampling rate of the A/D converter 175 can be one of five different sampling rates (e.g., 1024, 2048, 4096, 8192 or 16384 samples per second). The sampling rate used by the A/D converter 175 of the collection device 102 can be related to the ability of the collection device 102 to filter out any noise that is present in the analog data output from the sensor system 104 (i.e., pre-process the analog data) and in the ability of the A/D converter 175 to process the analog data. In one embodiment, the sampling rate can be inversely related to the resolution of the A/D converter 175, i.e., the greater the resolution of the A/D converter 175, the lower the sampling rate that can be used by the collection device 102.

In an embodiment, the A/D converter 175 can include 4 channels to receive analog data from the sensor system 104. The A/D converter 175 can designate 3 channels to receive analog data from a geophone and 1 channel to receive analog data from a microphone. However, other channel designations are possible in other embodiments. In another embodiment, the A/D converter 175 can have an additional 4 channels. The additional 4 channels of the A/D converter 175 can be used with a second geophone and microphone or with other sensors that measure different parameters (e.g., light, heat, pressure, etc.).

The sensor data 164 can include data and measurements from the corresponding sensor(s) of the sensor system 104. The sensor data 164 can include the digital data from the A/D converter 175 that converted the analog information (or data) from the sensor system 104 into a digital form. In one embodiment, the amount of sensor data 164 that can be stored in memory 155 can be limited by the amount space available in memory 155 and the resolution used to digitize the analog data output (i.e., the greater the number of bits used in digitizing the analog data, the fewer sensor data entries that can be stored). In another embodiment, the digital data from the A/D converter 175 can be processed using the configuration data 168 to improve the accuracy of the sensor data 164. For example, the configuration data 168 can include an offset or error value for the sensor system 104. The offset or error value can then be subtracted from the digital data value provide by the A/D converter 175 to correct for the error that may be present in the analog data from the sensor system 104. The offset or error value can be determined during a calibration process wherein the sensor system 104 is operated such that the output is supposed to be a zero. Any deviation of the output from zero during the calibration process can be used as the offset or error value when processing the digital data from the A/D converter 175.

FIG. 3 shows an embodiment of a sensor system 104. The sensor system 104 can include one or more analog sensors 110 to measure vibration, movement or sound and generate a corresponding analog signal for the measured vibration, movement or sound. The analog sensor(s) 110 can include a geophone (or seismometer), microphone or other similar type of sensor to measure vibration, movement or sound. In one embodiment, the analog sensor(s) 110 for the sensor system 104 can include a tri-axial geophone and a microphone. The tri-axial geophone can incorporate three sensors. The three sensors can include two sensors positioned 90 degrees apart to measure radial and transverse movements (in a horizontal plane) and a third sensor positioned 90 degrees from the other two sensors to measure vertical movements. In another embodiment, the analog sensor(s) 110 can also include temperature sensors, pressure sensors and/or light sensors.

The analog sensor(s) 110 can provide the analog signal(s) corresponding to the measured vibration, movement or sound (or to the measured temperature, pressure or light) to an analog section 116. After processing the analog signals from the sensor 110, the analog section 116 can provide the analog signals (i.e., the analog data) to a communication interface 112 that is coupled (e.g., wired or wirelessly) to the collection device 102. The communication interface 112 provides the appropriate interface with the collection device 102 to permit information and signals to be communicated between the collection device 102 and the sensor system 104. In one embodiment, the communication interface 112 can be separate from the analog section 116 and digital section 118 as shown in FIG. 3. However, in another embodiment, the analog section 116 and the digital section 118 can include corresponding portions of the communication interface 112 to enable the analog section 116 and the digital section 118 to individually communicate with the collection device 102. In an embodiment, the communication interface 112 can include a single digital connection (with a ground reference) to communicate digital data between the digital section 118 and the collection device 102 and at least one analog connection (with a ground reference) to communicate analog data between the analog section 116 and the collection device 102. In one embodiment, the at least one analog connection can include 1 analog connection to communicate analog data from a microphone and 3 analog connections to communicate analog data from a geophone.

The sensor system 104 can also include a power supply 114 and a digital section 118 that are coupled to the communication interface 112. The power supply 114 can be used to provide an appropriate power level to the analog sensor(s) 110 and to provide power to the components of the analog section 116. In one embodiment, the power supply can provide a sensor voltage of between about 3.3 VDC and about 5 VDC to the sensor(s) 110 to power the analog electronics inside the sensor(s) 110. In addition, the sensor voltage can be used to power the analog electronics of the analog section 116 inside the sensor system 104. In one embodiment, the power supply 114 can receive the corresponding sensor voltage and a reference voltage (discussed below) from the collection device 102 via the communication interface 112. The power supply 114 can then provide the sensor voltage and reference voltage to the sensor(s) 110 (e.g., a geophone and microphone) such that the sensor(s) 110 are using the same sensor voltage and reference voltage. In another embodiment, the power supply 114 can have an interface that permits the power supply 114 to plug into or otherwise interface with an external component, such as an electrical outlet or battery, and receive electrical power from the external component instead of the collection device 102.

The digital section 118 can provide information regarding the operation of the sensor system 104 and can be electrically (and otherwise) isolated from the analog section 116 (except for a common ground connection). The isolation of the digital section 118 from the analog section 116 can assist in maintaining the accuracy of the analog signals from the analog sensor 110 by limiting interference from the digital section 118.

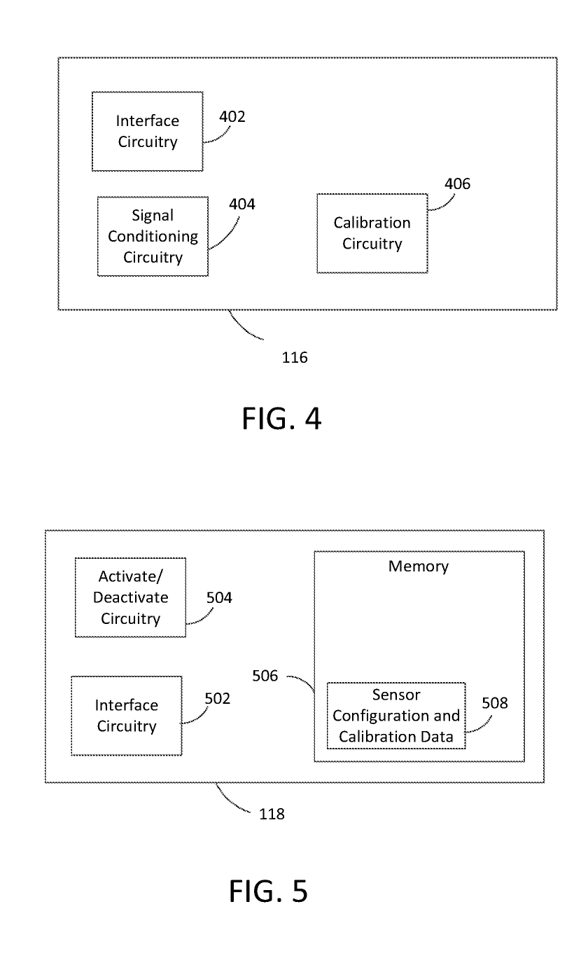

FIG. 4 shows an embodiment of the analog section 116. The analog section 116 includes interface circuitry 402 that can couple the analog section 116 to the analog sensor 110, the communication interface 112 and/or any other components of the sensor system 104. The analog signals from the sensor 110 can be received by the interface circuitry 402 and provided to the signal conditioning circuitry 404. The signal conditioning circuitry 404 can include filters, amplifiers, switches, diodes, resistors, capacitors and/or any other suitable circuit components. The signal conditioning circuitry 404 can process the analog signals (e.g., amplify) from the sensor 110 and generate analog data (based on the analog signals from the sensor 110) for the collection device 102. The analog section 116 can also include calibration circuitry 406 used to calibrate the output of the analog sensor 110.

The analog section 116 can also receive a reference voltage from the power supply 114 to set the steady state output voltage of the sensor 110. In one embodiment, the reference voltage can be one-half of the sensor voltage, but other values for the reference voltage can be used in other embodiments. The use of the reference voltage permits both positive and negative movements of the sensor(s) 110 (e.g., a geophone) to be able to determine the maximum range on both positive and negative displacement measurements. For example, if the sensor voltage is 3.3 VDC, then the reference voltage can be 1.65 VDC. The calibration circuitry 406 can apply a calibration voltage to the sensor 110 during a calibration process. The calibration voltage can be set to 0 VDC, the reference voltage or to the sensor voltage. The calibration voltage is used periodically to “zero” the sensor 110 or to determine if the sensor 110 is working properly. The calibration process can evaluate the sensor 110 by applying the reference voltage to the sensor 110 first, then applying 0 VDC, then further applying the sensor voltage and then the reference voltage again. The output of the sensor 110 can then be read by the calibration circuitry 406 to determine the zero point, full scale maximum and full scale minimum output of the sensor 110.

FIG. 5 shows an embodiment of the digital section 118. The digital section 118 has interface circuitry 502 that can be connected to the collection device 102 by a single connection (i.e., a single wire, channel or line). The single connection provided by the interface circuitry 502 can be used to enable the digital section 118 to communicate with the collection device 102 using single signals. By communicating using only single signals, the digital section 118 provides the collection device 102 with the ability to read information pertaining to the sensor system 104 through the single connection. The use of a single connection in the interface circuitry 502 by the digital section 118 can reduce the number of possible points or sources that can induce inaccuracies in the analog data output from the analog section 116 due to noise from the digital section 118. The single connection also serves as a power line for the digital section 118.

In one embodiment, the communication between the collection device 102 and the digital section 118 can occur using predetermined time slots for the collection device 102 and the digital section 118 to transmit data. Each time slot can be of a predetermined duration and can be 160 μs (microseconds) in one embodiment, but longer or shorter durations can be used for the time slots in other embodiments. For example, when the collection device 102 wants to obtain (or read) information from the digital section 118, the collection device 102 can provide a request having “1s” and “0s” to the digital section 118 to initiate communication between the digital section 118 and the collection device 102. Once communication has been initiated, the collection device 102 and the digital section 118 can transmit information to each other in their corresponding assigned time slot for communication. For example, the collection device 102 and the digital section 118 can alternate time slots for communication (e.g., one time slot for the collection device 102 followed by one time slot for the digital section 118). However, other time slot assignments could be used for communication (e.g., one slot for the collection device 102 followed by three time slots for the digital section 118).

The digital section 118 can include activate/deactivate circuitry 504 that can control the power for the digital section 118 based on signals received from the collection device 102 via the single connection. While the activate/deactivate circuitry 504 is shown separate from the interface circuitry 502 in FIG. 5, the activate/deactivate circuitry 504 can be integrated into the interface circuitry 502 in one embodiment. The digital section 118 can also include memory 506 that is used to store sensor configuration and calibration data 508. The sensor configuration and calibration data 508 can include information such as a sensor identifier, calibration dates and times (including the most recent calibration date and time), sensor range (e.g., a predetermined range of movement such as 10 inches), sensor offset (e.g., a predetermined deviation from a true zero position such as 0.1 inches), sensor span (e.g., a predetermined amount of movement before the sensor 110 start to register movement such as 12 to 22 inches), sensor non-linearity (e.g., a predetermined deviation from an ideal sensor output such as 0.01%), sensor manufacture date, sensor manufacturer, sensor type and any other statistical data. The sensor configuration and calibration data 508 can include information provided by the manufacturer of the sensor and/or information provided by the analog section 116 as a result of performing calibration processes. In one embodiment, the memory 506 can use non-volatile memory to store the sensor configuration and calibration data 508 (and other digital information), such that the information written to (stored by) the memory 506 is still available even though power has been turned off and re-applied by the activate/deactivate circuitry 504.

The activate/deactivate circuitry 504 can be used to initiate communication between the digital section 118 and the collection device 102 upon the receipt of a power signal from the collection device 102 via the single connection (e.g., the single connection is pulled “high”) and can terminate or end communication between the digital section 118 and the collection device 102 in response to the absence of the power signal from the collection device 102 via the single connection (e.g., the single connection is pulled “low”). In one embodiment, the activate/deactivate circuitry 504 can include a transistor configured with an open collector output pin that can be “powered on” by a power signal from the collection device 102 to permit the digital section 118 to send and receive data. A pullup resistor can be connected to the transistor to assist in the sending and receiving of digital data and to provide power to the digital section 118. The providing of the power signal over the single data connection allows the digital section 118 to be activated by the collection device 102 when the sensor configuration and calibration data 508 is needed by the collection device 102 and to be deactivated by the collection device 102 when the sensor configuration and calibration data 508 has been received by the collection device 102, thus allowing no digital error or noise to be induced into the sensor system 104 during analog sample times of the analog data output since the single connection is not being used for communications (i.e., there are no signals on the single connection).

In one embodiment, when the single connection is pulled high to power the digital section 118, the digital section 118 can output a signal to the collection device 102 informing the collection device 102 that sensor information is available. The collection device 102 can then send a series of digital data bytes to the digital section 118 to unlock and ask for sensor configuration and calibration data 508 stored in memory 506. The requested information is then provided from the digital section 118 to the collection device 102 over the single connection and is then stored as configuration data 168 in memory 155 of the collection device 102. In one embodiment, the digital section 118 can provide the series of digital data bytes to the collection device 102 using the transistor with the open collector output configuration and the pullup resistor as described above in the activate/deactivate circuitry 504. The collection device 102 can also use a similar open collector transistor and pullup resistor configuration to send and receive digital data bytes over the single connection. The pullup resistor can be used to assist in the sending and receiving of digital data and to power the transistor in the collection device 102. The pullup resistor can pull the output line low to send a “0” or leave the output line high to send a “1” to the digital section 118. The digital section 118 sends data back to the collection device 102 using a similar technique within the corresponding time slots as discussed above. The configuration data 168 can be used by the collection device 102 to determine what type of sensor 110 and what output scale is used by the sensor 110. Once all of the requested information has been received by the collection device 102, the digital section 118 is then powered off by driving the single connection low. In one embodiment, the single connection can be pulled high by a wide range of voltages (e.g., between about 3 V (volts) and about 5 V) for powering the digital section 118. By accepting a range of voltages, the digital section 118 can interface with collection devices 102 that provide voltages in the 3 V range or the 5V range.

The sensor configuration and calibration data 508 provided to the collection device 102 can enable the collection device 102 to determine the range of the sensor 110. For example, the collection device 102 can determine if the sensor 110 outputs 2 inches of movement or 10 inches of movement. In addition, the collection device 102 can determine the type of the sensor 110 and/or the engineering units used by sensor 110 from the sensor configuration and calibration data 508. The collection device 102 can also determine if the sensor 110 is configured for metric or imperial units. For example, the collection device 102 can be configured to receive analog data from the analog section 116 that corresponds to millimeters (mm) of movement or inches (in.) of movement based on the sensor configuration and calibration data 508 from the digital section 118.

In one embodiment, the digital information provided to the collection device 102 by the digital section 118 can be guaranteed to be accurate due by incorporating a CRC value into the sensor configuration and calibration data 508 being provided to the collection device 102. The CRC value can be used to check the validity of the data being provided by the digital section 118 to the collection device 102. In another embodiment, the digital information from the digital section 118 may be encrypted to prevent someone from being able to read and understand the information if the information is inappropriately accessed.

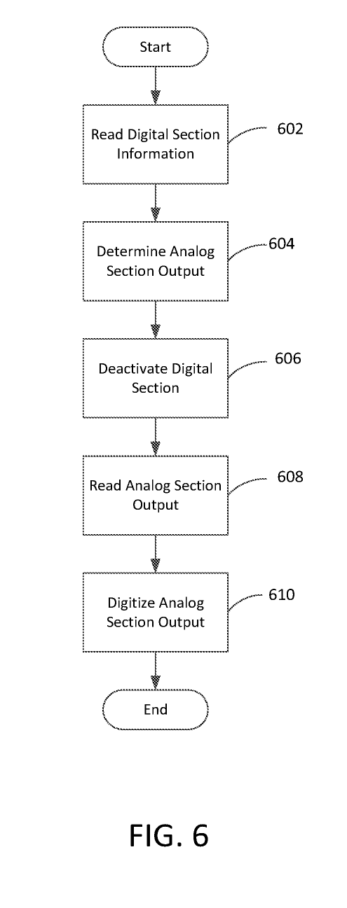

FIG. 6 is a flow chart of an embodiment of a process for providing sensor information from the sensor system 104 to the collection device 102. The process begins by the collection device 102 obtaining information on the analog sensor 110 from the digital section 118 (step 602). The collection device 102 can provide a power signal (or drive the connection high) to the digital section 118 to power the digital section 118 and submit a series of requests to obtain the desired information from the digital section 118. In one embodiment, the collection device 102 can transmit the power signal to the digital section 118 in response to the collection device 102 being activated or “powered on.” In another embodiment, the collection device 102 can transmit the power signal to the digital section 118 in response to the collection device 102 detecting the connection of a sensor system 104 to the collection device 102. The collection device 102 uses the information from the digital section 118 to determine the form of the analog data that will be received from the analog section 116 (step 604). In one embodiment, the determining of the form of the analog data can be used to “pre-calibrate” the analog sensor 110 for use with the collection device 102. In other words, since the collection device 102 already knows the form of the analog data to be provided by the analog section 116, the collection device 102 does not have to perform a calibration procedure in order to properly process the analog data from the analog section 116.

Once the collection device 102 has received of all the requested information from the digital section 118 and determined the form of the analog output, the collection device 102 can deactivate (or power off) the digital section 118 (step 606) by removing the power signal (or driving the connection low). When the digital section 118 has been deactivated, the collection device 102 can begin reading the analog data output from the analog section 116 (step 608). The analog section 116 can be activated (or powered on) in response to the deactivation of the digital section 118 or the analog section 116 can be previously activated (or powered) and not accessed by the collection device 102. As the collection device 102 receives the analog data from the analog section, the A/D converter 175 can be used to digitize the analog data (step 610) in accordance with the information from the digital section 118. The digitized data from the A/D converter 175 can then be stored as sensor data 164 in memory 155.

In one embodiment, the collection device 102 can have three monitoring modes for various situations: self-trigger, bar graph, and combo. In the self-trigger mode, the collection device 102 can monitor the digitized data from the A/D converter 175 for a threshold to be achieved (e.g., the corresponding sensor measurement represented by the digitized data exceeds a predetermined value). Once the threshold is achieved, a recording (i.e., the digitized data can be stored in sensor data 164) is made of the measurements from the analog sensor 110 (once converted to digital data by the A/D converter 175) for a predetermined number of seconds at the sample rate specified. In bar graph mode, the collection device 102 monitors the digitized data from the A/D converter 175 to determine the peak value of the digitized data within a predetermined time period. The collection device 102 can then save the peak value for the time period as sensor data 164. The interval (how often a value is selected from the samples) and period (how often the selected values are used to produce a peak value by determining the interval with the highest selected value) can be set by the user of the collection device 102. Combo mode can be a hybrid of the bar graph mode and the self-trigger mode. In combo mode, the collection device 102 operates similar to bar graph mode, but switches to self-trigger mode when the digitized data achieves the threshold.

Although the figures herein may show a specific order of method steps, the order of the steps may differ from what is depicted. Also, two or more steps may be performed concurrently or with partial concurrence. Variations in step performance can depend on the software and hardware systems chosen and on designer choice. All such variations are within the scope of the application. Software implementations could be accomplished with standard programming techniques, with rule based logic and other logic to accomplish the various connection steps, processing steps, comparison steps and decision steps.

It should be understood that the identified embodiments are offered by way of example only. Other substitutions, modifications, changes and omissions may be made in the design, operating conditions and arrangement of the embodiments without departing from the scope of the present application. Accordingly, the present application is not limited to a particular embodiment, but extends to various modifications that nevertheless fall within the scope of the application. It should also be understood that the phraseology and terminology employed herein is for the purpose of description only and should not be regarded as limiting.

What is claimed is:

1. A sensor system for a seismograph comprising:
a sensor to measure vibrations;
first circuitry coupled to the sensor, the first circuitry configured to receive a signal corresponding to the measured vibrations from the sensor and provide data corresponding to the measured vibrations to a collection device via at least one first connection; and
second circuitry comprising a memory device to store information related to the sensor, the second circuity configured to provide the stored information about the sensor to the collection device via a single second connection in response to receiving a signal from the collection device on the single second connection.

2. The sensor system of claim 1, wherein the second circuitry is configured to be deactivated in response to an absence of the signal from the collection device.

3. The sensor system of claim 2, wherein the first circuitry is configured to provide data corresponding to the measured vibrations to the collection device in response to the second circuitry being deactivated.

4. The sensor system of claim 1, wherein the first circuitry is isolated from the second circuitry.

5. The sensor system of claim 1, wherein the provided data corresponding to the measured vibrations is analog data.

6. The sensor system of claim 1, wherein the stored information about the sensor is digital data.

7. The sensor system of claim 1, wherein the second circuitry includes an open collector transistor coupled to the second single connection.

8. A seismograph comprising:
a collection device; and
a sensor system comprising:
a sensor, the sensor configured to measure movement and provide an analog signal corresponding to the measured movement;
a first section coupled to the collection device and to the sensor, the first section configured to process the analog signal from the sensor and provide analog data to the collection device; and
a second section coupled to the collection device, the second section configured to provide digital information about the sensor to the collection device; and
wherein the collection device is configured to receive the digital information from the second section and use the received digital information in processing the analog data from the first section.

9. The seismograph of claim 8, wherein the collection device comprises an analog to digital converter to process the analog data from the first section.

10. The seismograph of claim 8, wherein the second section is coupled to the collection device by a single connection.

11. The seismograph of claim 8, wherein the first section comprises signal conditioning circuitry to process the analog signal from the sensor.

12. The seismograph of claim 8, wherein the second section comprises memory configured to store the digital information, the digital information including at least one of a sensor identifier, a calibration date for the sensor, a range for the sensor range, an offset for the sensor, a span for the sensor, a non-linearity parameter for the sensor, a sensor manufacture date, a sensor manufacturer or a sensor type.

13. The seismograph of claim 8, wherein the second section comprises a transistor having an open collector and a pullup resistor coupled to the transistor, wherein the transistor is configured to provide the digital information to the collection device in response to receiving a signal from the collection device.

14. A method of providing sensor information to a collection device, the method comprising:
obtaining, by a collection device, operating information related to a sensor from the sensor;
determining, by the collection device, an output data format for the sensor based on the obtained operating information;
receiving, by the collection device, analog data from the sensor corresponding to measured vibrations by the sensor; and
converting, by the collection device, the analog data from the sensor to digital data based on the determined output data format.

15. The method of claim 14, wherein the obtaining operating information includes sending, by the collection device, a signal to the sensor via a single connection and providing, by the sensor, the operating information in response to the signal being present on the single connection.

16. The method of claim 15, further comprising removing the signal from the single connection prior to the receiving analog data.

17. The method of claim 14, wherein the converting the analog data includes converting the analog data from the sensor to the digital data with an analog to digital converter at a predetermined sample rate, wherein the predetermined sample rate is based on the operating information.

18. The method of claim 17, wherein a resolution of the digital data converted by the analog to digital converter is based a resolution of the analog data included in the operating information.
